(19) United States
(12) Patent Application Publication
(10) Pub. No.: US 2018/0300780 A1
(43) Pub. Date: Oct. 18, 2018

(54) SOCIAL SELLING INDEX

(71) Applicant: Linkedin Corporation, Sunnyvale, CA (US)

(72) Inventors: Steven H. Kaplan, San Francisco, CA (US); Lauren Mullenholz, San Francisco, CA (US); Nikola Mijic, San Francisco, CA (US); Jing Feng, Cupertino, CA (US); Chencheng Wu, Sunnyvale, CA (US); Akshay Rajan Kantak, Sunnyvale, CA (US); Abhishek Gupta, San Francisco, CA (US)

(21) Appl. No.: 15/485,796

(22) Filed: Apr. 12, 2017

(51) Int. Cl. G06Q 30/06; G06Q 50/00

(52) U.S. Cl. CPC G06Q 30/0601; G06T 11/206; G06Q 50/01

(57) ABSTRACT

Methods, systems, and computer program products for a distributed processing system and database for managing, performing, measuring, evaluating, codifying, and teaching social selling are described. Metric data corresponding to a user of a social network system is obtained and one or more components of a social selling index score are computed. The social selling index score is computed based on the one or more components. A graphical interface, using at least one hardware processor, is generated based on the one or more components and the social selling index score, the graphical interface having a first portion that includes a chart representing a first element associated with the social selling index score and a second portion that includes text representing a second element associated with the social selling index score.

### TECHNICAL FIELD

The present disclosure relates generally to a distributed processing system and database for social selling. More specifically, the disclosure relates to a distributed processing system and database for measuring, evaluating, rating, teaching, and managing social selling using a social selling index.

### BACKGROUND

Social media and networking websites maintain a wealth of information on companies, organizations, employees, members, government entities, groups of members, and the like. As a result, social media and networking websites often provide an efficient platform for social selling. Some members of the social media and networking websites may be more proficient than other members at conducting social selling.

### DESCRIPTION OF THE DRAWINGS

Some embodiments are illustrated by way of example and not limitation in the accompanying drawings, in which:

FIG. 1A is a block diagram illustrating a networked system, in accordance with an example embodiment;

FIG. 1B illustrates the social networking server of FIG. 1A, in accordance with an example embodiment;

FIG. 2A is an example user interface for a microsite user dashboard, in accordance with an example embodiment;

FIG. 2B is an example user interface for a team dashboard, in accordance with an example embodiment;

FIG. 2C is a detailed view of the histogram of FIG. 2B, in accordance with an example embodiment;

FIG. 2D is a detailed view of the donut graph and the sliders of FIG. 2B, in accordance with an example embodiment;

FIG. 2E is a detailed view of the team leader board of FIG. 2B, in accordance with an example embodiment;

FIG. 3 is an example user interface for displaying usage statistics associated with a team, in accordance with an example embodiment;

FIG. 4A shows usage charts associated with a team, in accordance with an example embodiment;

FIG. 4B shows the daily view of the usage charts when the months selected are within 90 days, in accordance with an example embodiment;

FIG. 4C is the view of the usage charts when the user selects date ranges beyond 90 days, in accordance with an example embodiment;

FIG. 5A is a block diagram of an example high-level architecture for an social selling index (SSI) system, in accordance with an example embodiment;

FIG. 5B is a logical diagram of metric data maintained in a metrics database, in accordance with an example embodiment;

FIG. 6 shows an example high level usage reporting design and the main blocks of the usage reporting architecture, in accordance with an example embodiment;

FIG. 7 is a flowchart of an example method for generating an SSI user score set, in accordance with an example embodiment;

FIG. 8 is a flowchart of an example method for generating an SSI team score set, in accordance with an example embodiment;

FIG. 9 is a flowchart of an example method for generating the user dashboard 104, in accordance with an example embodiment;

FIG. 10 is a flowchart of an example method for generating the team dashboard, in accordance with an example embodiment;

FIG. 11 shows a flowchart for an example method for generating an example team usage report, in accordance with an example embodiment;

FIG. 12 is a block diagram illustrating a mobile device, according to an example embodiment; and

FIG. 13 is a block diagram of a machine in the form of a computer system within which a set of instructions may be executed for causing the machine to perform any one or more of the methodologies discussed herein.

### DETAILED DESCRIPTION

The present disclosure describes methods, systems, and computer program products for determining a function of an entity. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations, permutations and combinations of the various features and elements described herein.

Generally, the present disclosure describes methods, systems, and computer program products for a distributed processing system and database for managing, performing, measuring, evaluating, rating, codifying, and teaching social selling. In one example embodiment, a SSI is generated and used to measure a member's social selling performance, identify members that are proficient or deficient at social selling, develop suggestions and training for social selling, and the like. In general, a social selling index is an aggregate score that measures a member's proficiency of social selling. The aggregate score may represent the effectiveness of a user's adoption of social selling best practices.

### Social Networks

Online or web-based social network services provide their users with a mechanism for defining, and memorializing in a digital format, their relationships with other people. This digital representation of real-world relationships is frequently referred to as a social graph. As these social network services have matured, many of the services have expanded the concept of a social graph to enable users to establish or define relationships or associations with any number of entities and/or objects in much the same way that users define relationships with other people. For instance, with some social network services and/or with some web-based applications that leverage a social graph that is maintained by a third-party social network service, users can indicate a relationship or association with a variety of real-world entities and/or objects. For example, users may take action to expressly indicate a favorable opinion of, or an interest in, different types of content (e.g., web-based articles, blog postings, books, photographs, videos, audio recordings, music, and the like). Typically, a user's expression of opinion or interest is captured when a user interacts with a particular graphical user interface element, such as a button, which is generally presented in connection with the particular entity or object and frequently labelled in some meaningful way (e.g., “like,” “+1,” “follow”).

### Member Profiles

In addition to hosting a vast amount of social graph data, many social network services maintain a variety of personal information about their members. For instance, with many social network services, when a user registers to become a member, the member is prompted to provide a variety of personal or biographical information, which may be displayed in a member's personal web page. Such information is commonly referred to as personal profile information, or simply “profile information,” and when shown collectively, it is commonly referred to as a member's profile. For instance, the personal information that is commonly requested and displayed as part of a member's profile includes a person's age, birthdate, gender, interests, contact information, residential address, home town and/or state, the name of the person's spouse and/or family members, and the like. With certain social network services, such as some business or professional network services, a member's personal information may include information commonly included in a professional resume or curriculum vitae, such as information about a person's education, the company at which a person is employed, an industry in which a person is employed, a job title or function, an employment history, skills possessed by a person, professional organizations of which a person is a member, and so on.

### Member Registration

Consistent with some embodiments, when a person initially registers to become a member of the social network service, the person may be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and the like. This information is stored, for example, in member profiles.

Once registered, a member may invite other members, or may be invited by other members, to connect via the social network service. A “connection” may call for a bi-lateral agreement by the members, such that both members acknowledge the establishment of the connection. Similarly, with some embodiments, a member may elect to “follow” another member. In contrast to establishing a “connection,” the concept of “following” another member typically may be a unilateral operation, and at least with some embodiments, may not call for acknowledgement or approval by the member that is being followed. When one member follows another, the member who is following may receive automatic notifications about various activities undertaken by the member being followed. In addition to following another member, a user may elect to follow a company, a topic, a conversation, or some other entity, which may or may not be included in the social graph.

### Social Network Services

Because social network services are a rich source of information about people, social network services are an extremely useful tool when performing certain tasks. For example, many people use social network services to search for, and/or browse, member profiles that exhibit various desired characteristics. For instance, a job recruiter may search for persons who have profiles indicating the possession of certain technical skills and educational and professional experiences and backgrounds. Similarly, when someone needs to hire a person employed in a particular profession (e.g., a general contractor, a doctor, a lawyer, a landscaper, a plumber, an investment banker, and so forth), that person may turn to a social network service to identify persons who possess the requisite skills and qualifications. In another scenario, a person may desire to contact someone for the purpose of exploring or proposing the possibility of a particular business arrangement or relationship. Accordingly, the person may use a social network service to identify the appropriate persons to contact. In another scenario, a person may utilize the social network to perform social selling.

The SSI is an aggregate score that measures, for example, client adoption of social selling best practices in a social network. In one example embodiment, the SSI measures the success of a sales professional based on a comprehensive understanding of the member's activities on the social network. In addition, usage reporting allows users, such as administrators, to take a look at how a team of users is performing and how people rank on their team with regards to certain key metrics. In one example embodiment, the SSI is based on four components (known as pillars herein) and 46 metrics associated with each member over specified periods of time.

In one example embodiment, examples of a pillar and the corresponding metrics include:
1. Create Your Professional Brand, including
   a) a count of positions on a member's profile;
   b) a member profile picture status (e.g., present or absent);
2. Find the Right People, including
   a) a count of searches conducted by a member;
   b) a count of advanced people searches conducted by a member;
3. Engage with Insights, including
   a) a count of items shared with other members;
   b) a count of accounts saved;
4. Build Strong Relationships, including
   a) a count of member connections;
   b) a count of internal team connections.

In one example embodiment, each pillar accounts for 25% of the SSI score; the SSI score is calculated by summing the products created by multiplying each pillar by 0.25. Each pillar is computed by normalizing each metric of the corresponding pillar to between zero and one, and then summing the products generated by dividing each normalized metric by a count of metrics used to determine the corresponding pillar.

In one example embodiment, a set of cards is created that contain the next steps for the user to improve the score of his team. The next steps may begin with content about what the SSI score is, white-papers for rolling out social selling in the organization, and the like.

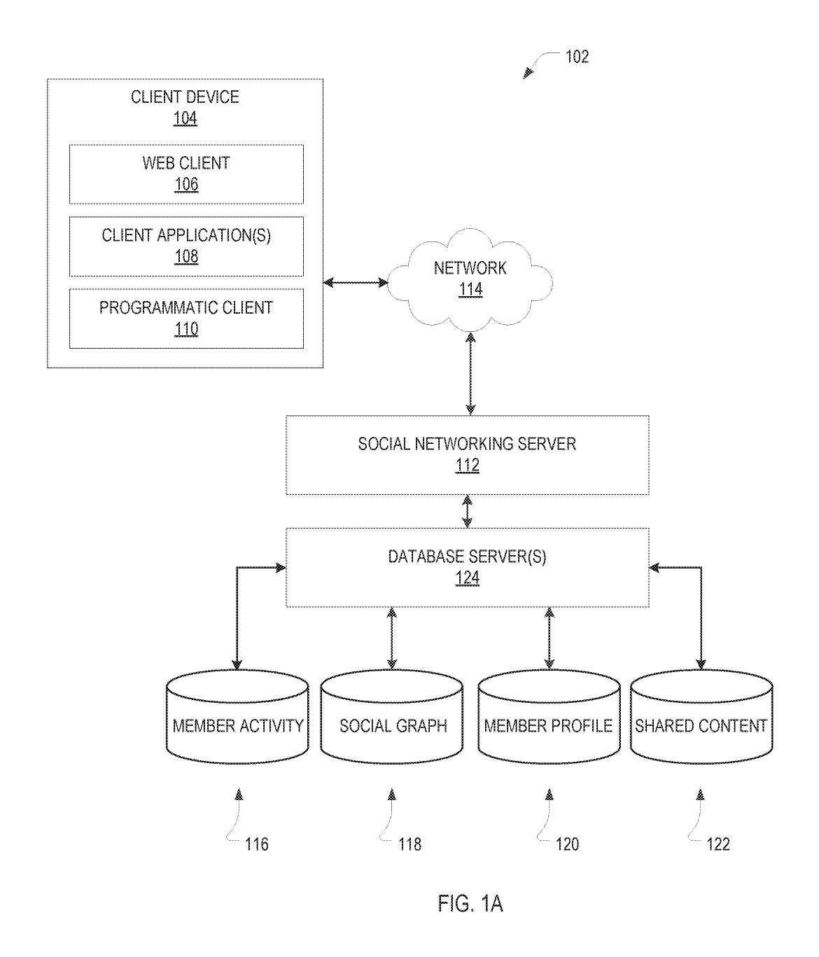

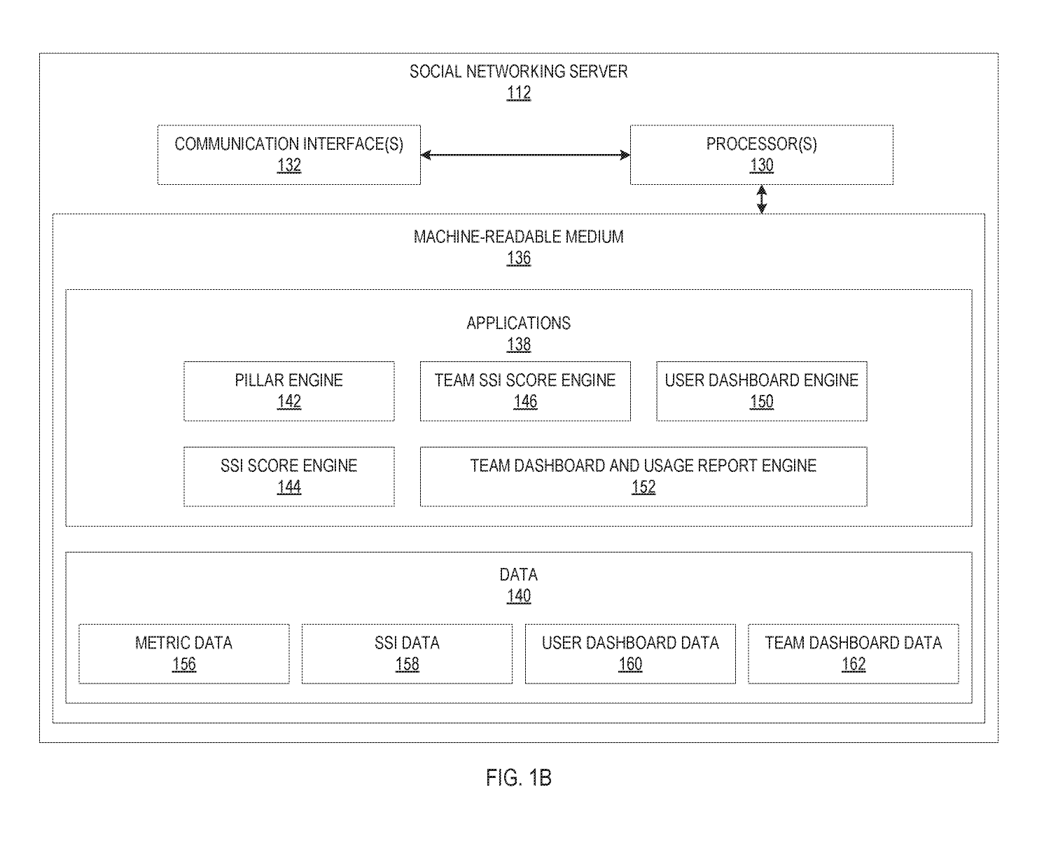

FIG. 1A is a block diagram illustrating a networked system, according to some example embodiments. With reference to FIG. 1A, an example embodiment of a high-level client-server-based network architecture 102 is shown. A social networking server 112 provides server-side functionality via a network 114 (e.g., the Internet or a wide area network (WAN)) to one or more client devices 104. FIG. 1A illustrates, for example, a web client 106 (e.g., a browser, such as the Internet Explorer® browser developed by Microsoft® Corporation of Redmond, Wash. State), client application(s) 108, and a programmatic client 110 executing on the client device 104. The social networking server 112 is further communicatively coupled with one or more database servers 124 that provide access to one or more databases 116-122.

The client device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronic system, or any other communication device that a user may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth. The client device 104 may be a device of a user that is used to perform one or more searches for user profiles accessible to, or maintained by, the social networking server 112. The client device 104 may also be configured to communicate content to and/or from the social networking server 112, such as content that is displayable on a web page provided by the social networking server 112.

In one embodiment, the social networking server 112 is a network-based appliance that responds to initialization requests or search queries from the client device 104. One or more users may be a person, a machine, or another means of interacting with the client device 104. In various embodiments, the user is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi® network, a WiMax network, another type of network, or a combination of two or more such networks.

The client device 104 may include one or more applications (also referred to as “apps”) such as, but not limited to, a web browser, a messaging application, an electronic mail (email) application, a social networking access client, and the like. In some embodiments, if the social networking access client is included in the client device 104, then this application is configured to locally provide the user interface and at least some of the functionalities of a social networking service, with the application configured to communicate with the social networking server 112, on an as-needed basis, for data and/or processing capabilities not locally available (e.g., to access a member profile, to authenticate a user, to identify or locate other connected members, etc.). Conversely, if the social networking access client is not included in the client device 104, the client device 104 may use its web browser to access the initialization and/or search functionalities of the social networking server 112.

One or more users may be a person, a machine, or another means of interacting with the client device 104. In example embodiments, the user is not part of the network architecture 102, but may interact with the network architecture 102 via the client device 104 or other means. For instance, the user provides input (e.g., touch screen input or alphanumeric input) to the client device 104 and the input is communicated to the social networking server 112 via the network 114. In this instance, the social networking server 112, in response to receiving the input from the user, communicates information to the client device 104 via the network 114 to be presented to the user. In this way, the user can interact with the social networking server 112 using the client device 104.

Further, while the client-server-based network architecture 102 shown in FIG. 1A employs a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 124 and/or database(s) 116-122. In one embodiment, the social networking server 112 is communicatively coupled to a member activity database 116, a social graph database 118, a member profile database 120, and a shared content database 122. The databases 116-122 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some embodiments, when a person initially registers to become a member of the social networking service provided by the social networking server 112, the person is prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. In some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some embodiments, importing or otherwise accessing data from one or more externally hosted data sources may enhance profile data for both members and organizations. For instance, with companies in particular, financial data may be imported from one or more external data sources, and made part of a company's profile.

Members of the social networking service may establish connections with one or more other members and/or organizations of the social networking service. The connections may be defined as a social graph, where a vertex in the social graph represents the member and/or organization and the edges identify connections among vertices. In this regard, the edges may be bilateral (e.g., two members and/or organizations have agreed to form a connection), unilateral (e.g., one member has agreed to form a connection with another member), or combinations thereof. In this manner, members are said to be first-degree connections of each other where a single edge connects the vertices representing the members; otherwise, members are said to be “nth”-degree connections of each other where “n” is defined as the number of edges separating the two vertices representing the members. As an example, two members are said to be “2nd-degree” connections of each other where each member shares a connection in common with the other member, but the members are not directly connected to one another. In one embodiment, the social graph maintained by the social networking server 112 is stored in the social graph database 118.

Although the foregoing discussion refers to a “social graph” in the singular, one of ordinary skill in the art will recognize that the social graph database 118 may be configured to store multiple social graphs. For example, and without limitation, the social networking server 112 may maintain multiple social graphs, where each social graph corresponds to various geographic regions, industries, members, or combinations thereof.

As members interact with the social networking service provided by the social networking server 112, the social networking server 112 is configured to monitor these interactions. Examples of interactions include, but are not limited to, commenting on content posted by other members, viewing member profiles, editing or viewing a member's own profile, sharing content outside of the social networking service (e.g., an article provided by an entity other than the social networking server 112), updating a current status, posting content for other members to view and/or comment on, and other such interactions. In one embodiment, these interactions are stored in the member activity database 116, which associates interactions made by a member with his or her member profile stored in the member profile database 120.

In one embodiment, the social networking server 112 communicates with the various databases 116-122 through the one or more database server(s) 124. In this regard, the database server(s) 124 provide one or more interfaces and/or services for providing content to, modifying content in, removing content from, or otherwise interacting with the databases 116-122. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates directly with the databases 116-122 and includes a database client, engine, and/or module for providing data to, modifying data stored within, and/or retrieving data from the one or more databases 116-122.

While the database server(s) 124 are illustrated as a single block, one of ordinary skill in the art will recognize that the database server(s) 124 may include one or more such servers. For example, the database server(s) 124 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-122, or combinations thereof. Accordingly, and in one embodiment, the database server(s) 124 implemented by the social networking service are further configured to communicate with the social networking server 112.

FIG. 1B illustrates the social networking server 112 of FIG. 1A, according to an example embodiment. In one embodiment, the social networking server 112 includes one or more processor(s) 130, one or more communication interface(s) 132, and a machine-readable medium 136 that stores computer-executable instructions for one or more applications 138 and data 140 used to support one or more functionalities of the applications 138.

The various functional components of the social networking server 112 may reside on a single device or may be distributed across several computers in various arrangements. The various components of the social networking server 112 may, furthermore, access one or more databases (e.g., databases 116-122 or any of data 140), and the various components of the social networking server 112 may be in communication with one another. Further, while the components of FIG. 1B are discussed in the singular sense, it will be appreciated that in other embodiments multiple instances of the components may be employed.

The one or more processors 130 may be any type of commercially available processor, such as processors available from the Intel Corporation, Advanced Micro Devices, or Texas Instruments, or other such processors. Further still, the one or more processors 130 may include one or more special-purpose processors, such as a Field-Programmable Gate Array (FPGA) or an Application-Specific Integrated Circuit (ASIC). The one or more processors 130 may also include programmable logic or circuitry that is temporarily configured by software to perform certain operations. Thus, once configured by such software, the one or more processors 130 become specific machines (or specific components of a machine) uniquely tailored to perform the configured functions and are no longer general-purpose processors.

The one or more communication interfaces 132 are configured to facilitate communications among the client device 104, the social networking server 112, and one or more of the database server(s) 124 and/or databases 116-122. The one or more communication interfaces 132 may include one or more wired interfaces (e.g., an Ethernet interface, a Universal Serial Bus (USB) interface, a Thunderbolt® interface, etc.), one or more wireless interfaces (e.g., an IEEE 802.11b/g/n interface, a Bluetooth® interface, an IEEE 802.16 interface, etc.), or combinations of such wired and wireless interfaces.

The machine-readable medium 136 includes various applications 138 and data 140 for implementing the social networking server 112. The machine-readable medium 136 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the applications 138 and the data 140. Accordingly, the machine-readable medium 136 may be implemented as a single storage apparatus or device, or, alternatively and/or additionally, as “cloud-based” storage systems or storage networks that include multiple storage apparatus or devices. As shown in FIG. 1B, the machine-readable medium 136 excludes signals per se.

In one embodiment, the applications 138 are written in a computer-programming and/or scripting language. Examples of such languages include, but are not limited to, C, C++, C#, Java, JavaScript, Perl, Python, or any other computer-programming and/or scripting language now known or later developed.

With reference to FIG. 1B, the applications 138 of the social networking server 112 include, but are not limited to, a pillar engine 142, an SSI score engine 144, a team SSI score engine 146, a user dashboard engine 150, and a team dashboard and usage report engine 152. The data 140 of the social networking server 112 include, but are not limited to, metric data 156, SSI data 158, user dashboard data 160, and team dashboard data 162. While the social networking server 112 may include alternative and/or additional applications (e.g., a networking application, a printing application, a software-implemented keyboard, etc.), such alternative and/or additional applications are not germane to this disclosure and the discussion of such is hereby omitted for brevity and readability.

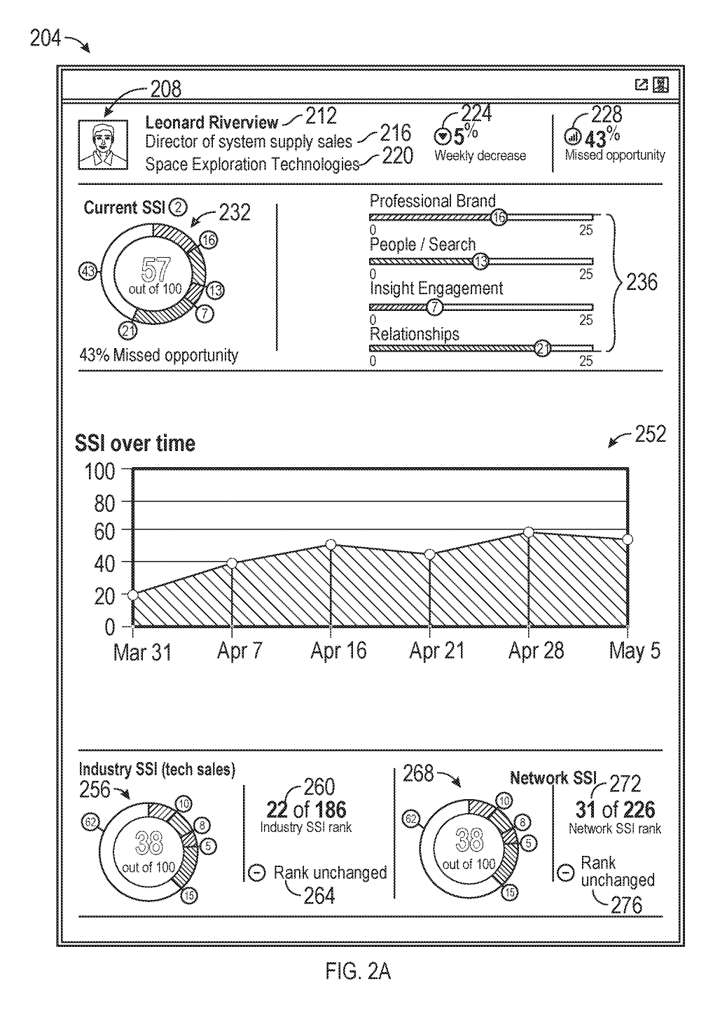

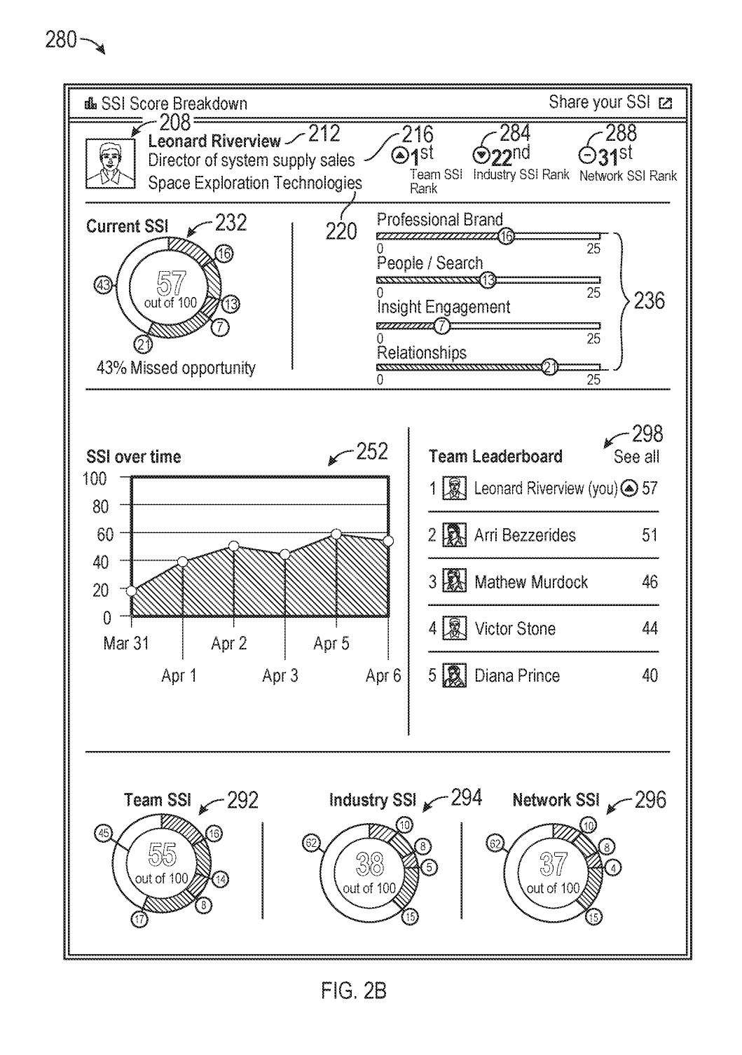

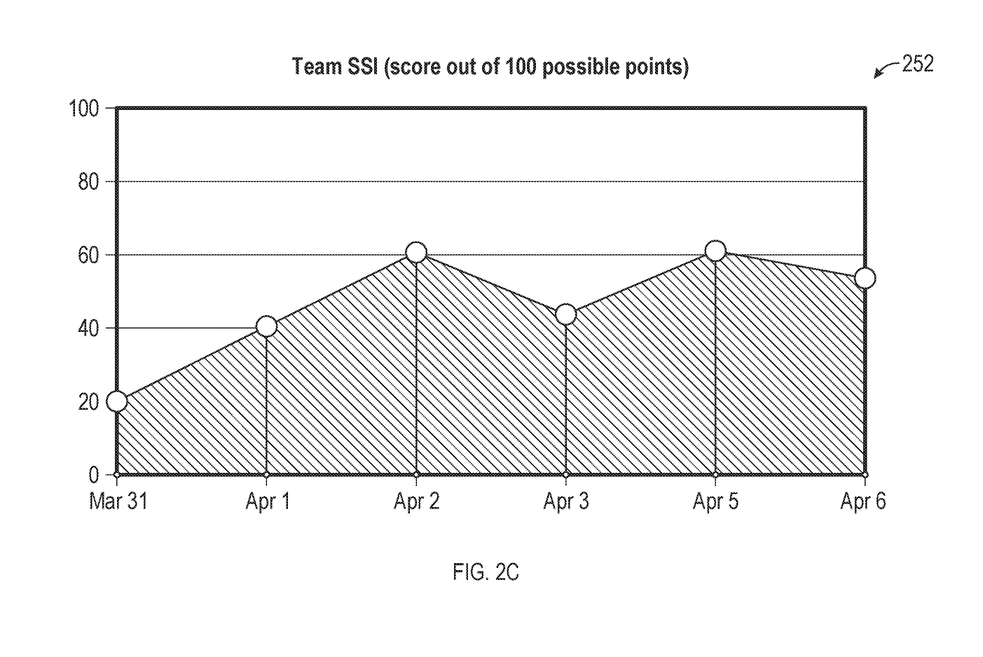

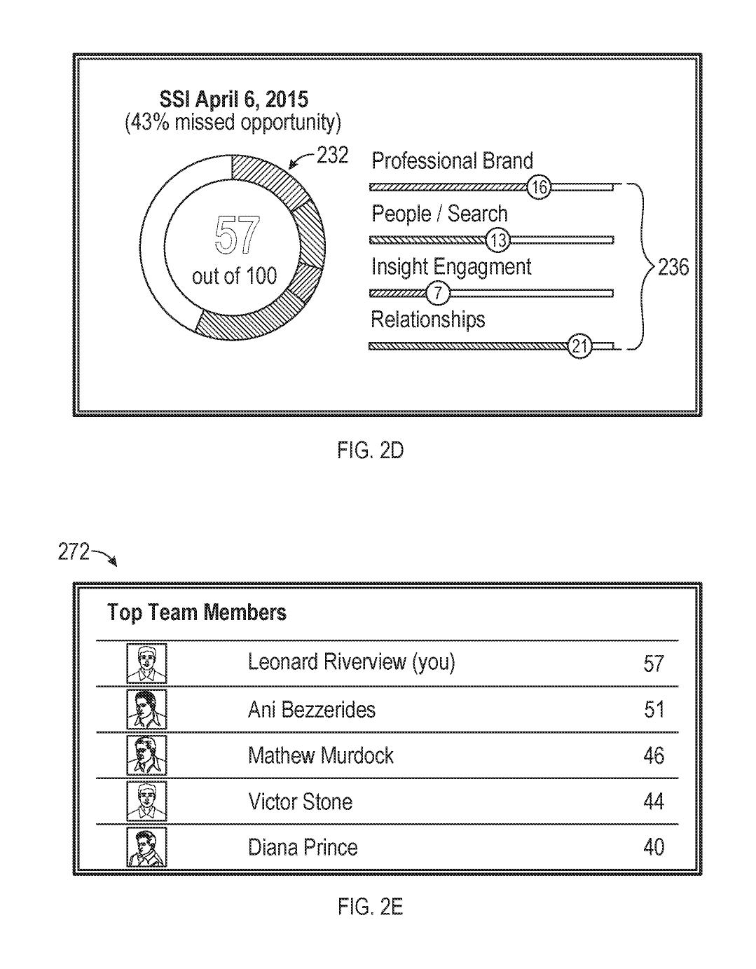

The SSI score engine 144 generates an SSI score set that may include a donut chart representing an average SSI score of the user's industry, the user's rank in the industry, the user's recent rank movement in the industry, and the like, as described below by way of example in conjunction with FIGS. 2A and 2B. The pillar engine 142 generates the pillars of the SSI score set.

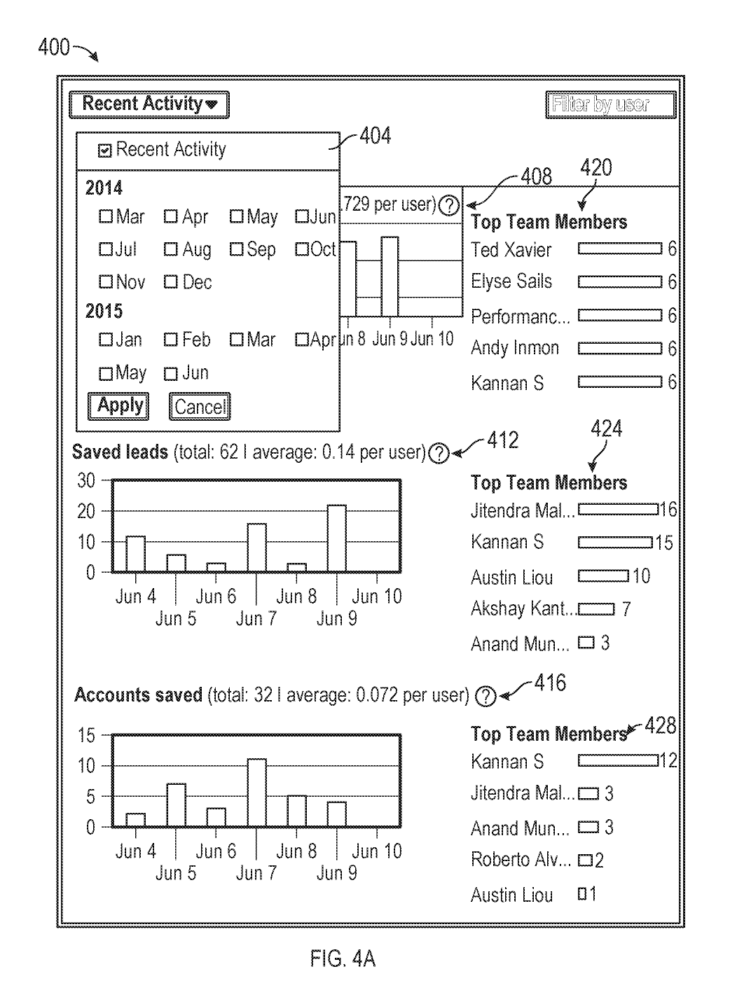

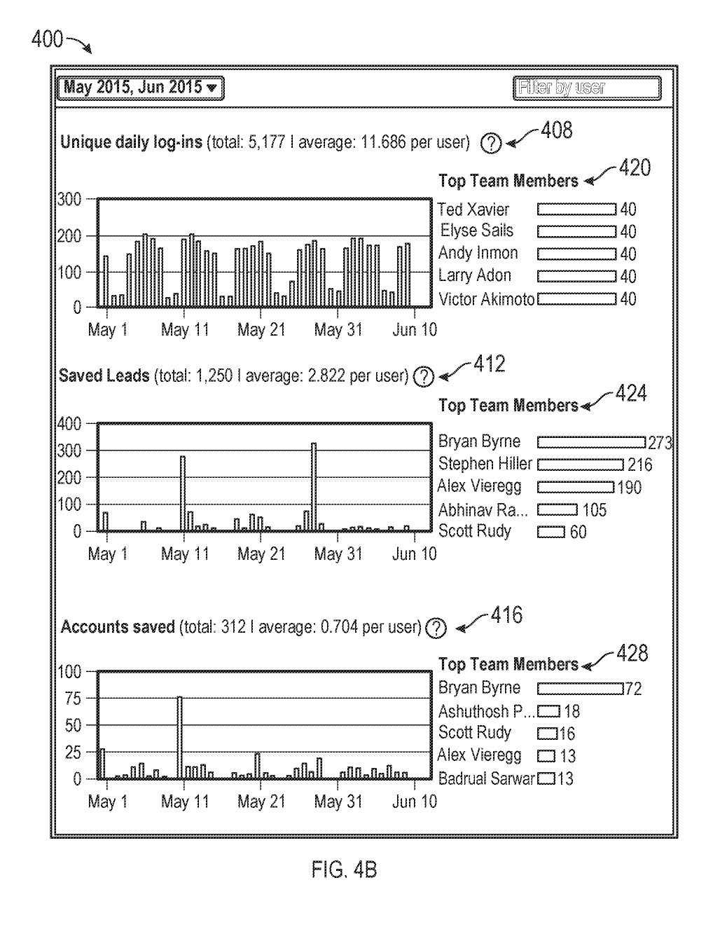

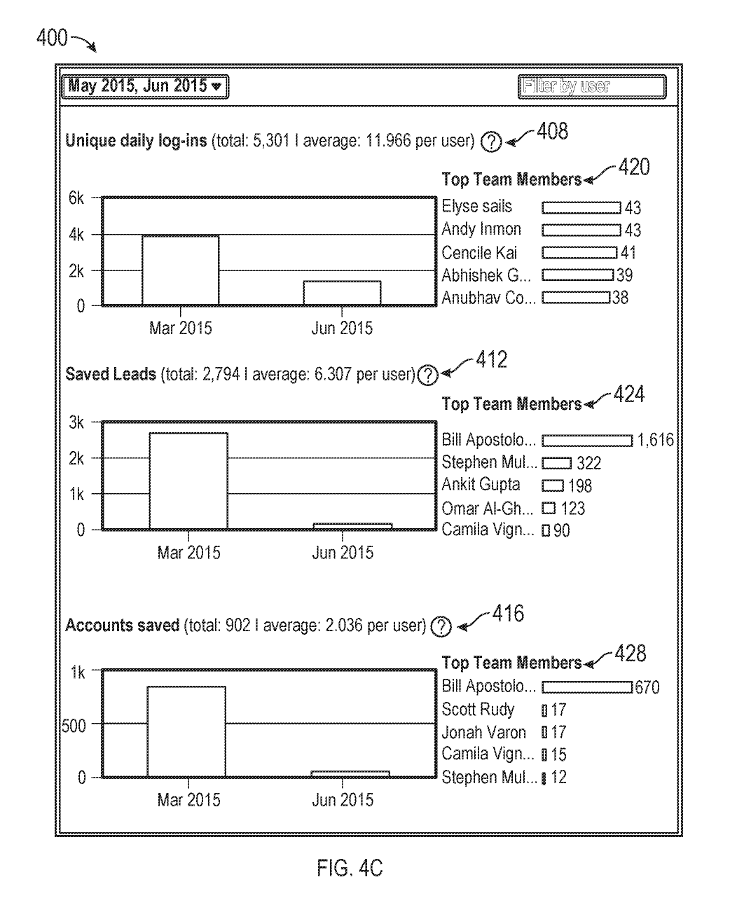

The team SSI score engine 146 generates a team SSI score set that may include a donut chart representing an average SSI score of the user's team, the user's rank in the team, the user's recent rank movement in the team, and the like, as described below by way of example in conjunction with FIG. 4A.

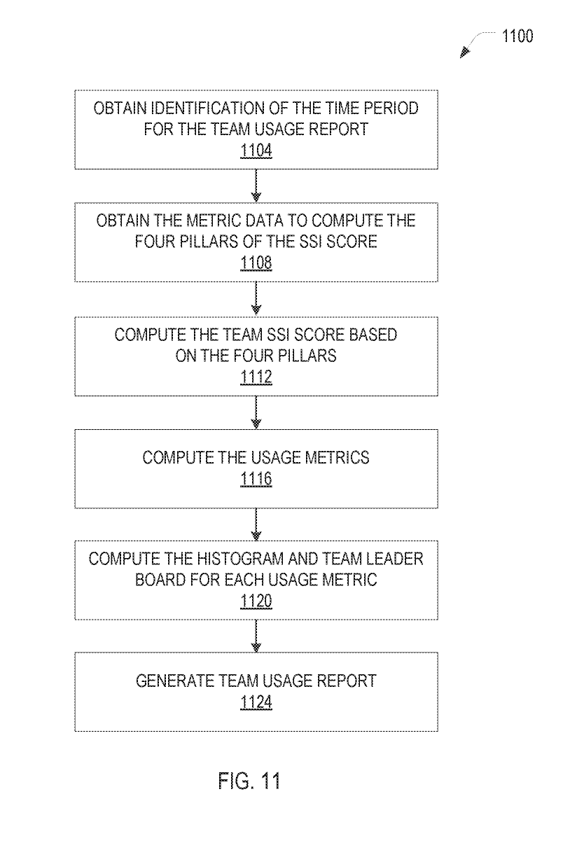

The user dashboard engine 150 generates a microsite user dashboard, as described below by way of example in conjunction with FIG. 2A. The team dashboard and usage report engine 152 generates a team dashboard that has certain key metrics that allow users to view a team's performance, the performance of individual members of the team, a member's rank on the team (e.g., top five members in the team for each metric), and the like, as described below by way of example in conjunction with FIG. 2B. The team dashboard and usage report engine 152 also generates usage reports, such as saved leads, accounts saved, and the like, as described below by way of example in conjunction with FIGS. 4A and 11.

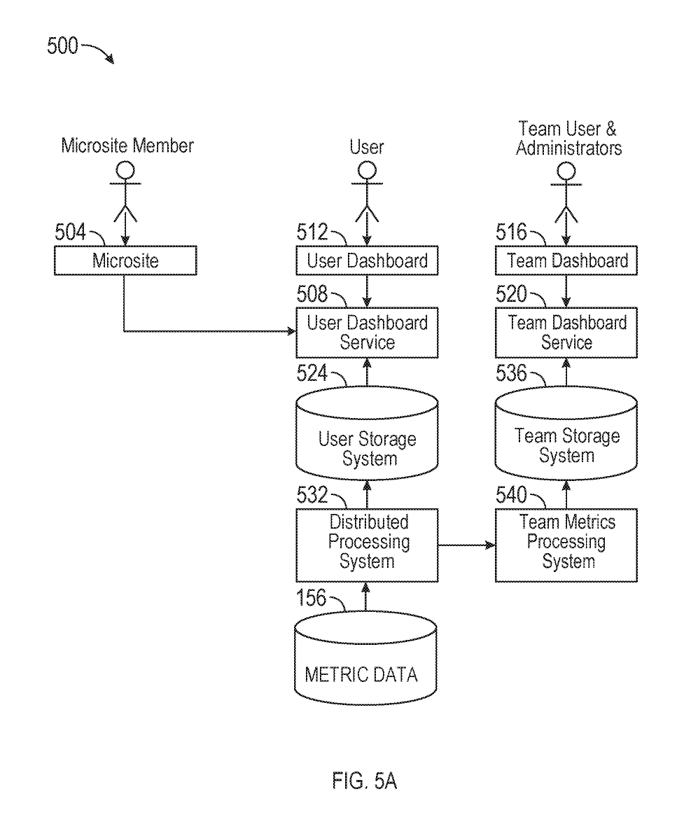

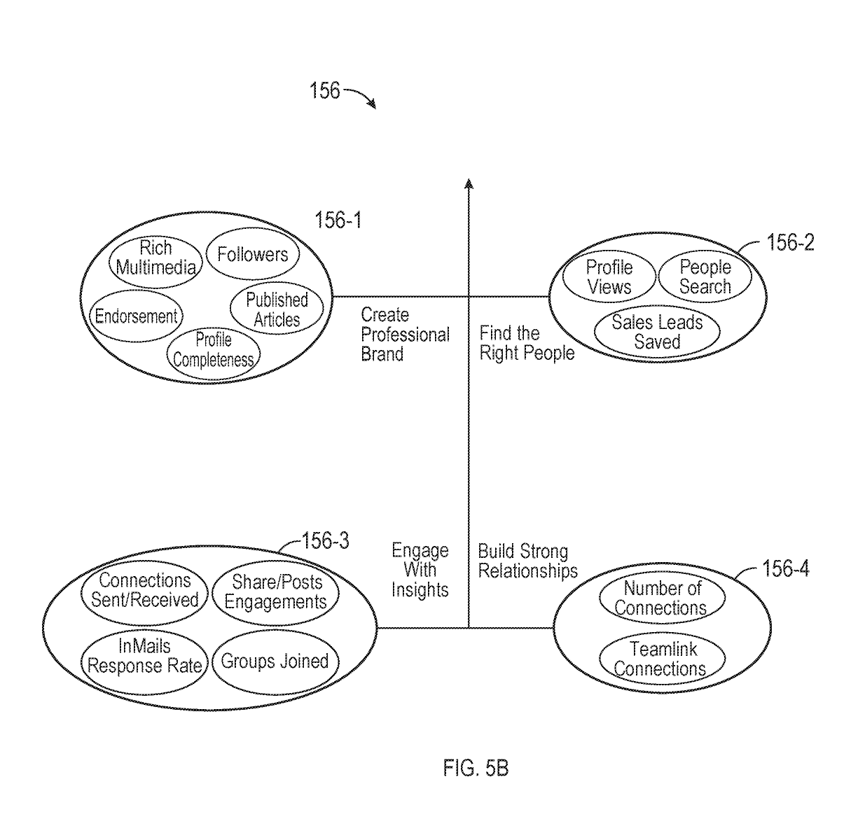

The metric data 156 contains data used to compute the pillars that compose the SSI score, as described below by way of example in conjunction with FIG. 5B. The SSI data 158 contains the SSI score sets generated by the SSI score engine 144. The user dashboard data 160 contains data for generating the user dashboard 104. The team dashboard data 162 contains data for generating the team dashboard 516.

SSI Microsite Dashboard

FIG. 2A is an example user interface for a microsite user dashboard 204, in accordance with an example embodiment. In one example embodiment, the microsite user dashboard 204 is generated by the user dashboard engine 150 and presented to a user, where the top card (e.g., the first page) of the user dashboard 204 contains identity details (e.g., a user profile picture 208, a user name 212, a user title 216, a user company 220, and the like) and key metrics (e.g., a weekly percentage change 224 in the SSI score, a missed opportunities metric 228, and the like). A graph of the latest SSI score and how it breaks down into the four key pillars may also be generated and displayed. These include a donut chart 232 with breakdowns into the four pillars, sliders 236 depicting each of the four pillars, tooltips for each of the four pillars and the overall score, and the like. A histogram 252 of the user's score over time may be generated and presented, and may include week-over-week SSI scores to illustrate the trend over, for example, the past month. Tooltips may be displayed as a user hovers a cursor over each individual data point. Clicking on one of the data points in the histogram will update the donut chart 232 and sliders 236 for the selected date. By default, the SSI score for the latest date in the histogram will be shown in the donut chart 232 and sliders 236. Tooltips explaining the score and score components will be provided by hovering a cursor over the corresponding score or score component.

In one example embodiment, data, such as the SSI score and corresponding metrics, are pre-computed on a distributed processing system pipeline and pushed to a storage system for analytics data, as described more fully below by way of example in conjunction with FIG. 5A. A distributed processing system, such as Apache Hadoop, is an open-source software framework for distributed storage and processing of very large data sets. Apache Hadoop includes a storage component, Hadoop Distributed File System (HDFS), and a processing part component, MapReduce. Hadoop uses a technique of splitting files into large blocks and distributing the data to a cluster of nodes. This technique enables the data to be processed faster and more efficiently.

In one example embodiment, an SSI score set may be generated by the SSI score engine 144 and displayed for an industry, and may include a donut chart 256 representing an average SSI score of the user's industry, the user's rank 260 in the industry, the user's recent rank movement 264 in the industry, and the like. In one example embodiment, an SSI score set may be generated and displayed for the user's social network, and may include a donut chart 268 representing an average SSI score of the members in the user's social network, the user's rank 272 in the user's social network, the user's recent rank movement 276 in the user's social network, and the like.

In one example embodiment, a top five list of users in terms of the SSI score may include a profile picture, name, score, and the like for each user and may be shown in descending order based on the SSI score. Clicking on one of the users will display a comprehensive SSI dashboard for that user. (Clicking on the histogram will not change this view as it is for the designated time period.) In one example embodiment, one way the top five list would change is when a user changes the date ranges. Searching for a user (filtering by user) would also change this list and show only the selected user/users in the list. In one example embodiment, this list will be the top five members for the selected time period.

In one example embodiment, the user can share with other users their SSI score set, along with an image depicting a breakdown of the SSI score, promotional text explaining the SSI score, a microsite link for other users to check their own score, and the like.

FIG. 2B is an example user interface for a team dashboard 280, in accordance with an example embodiment. The team dashboard 280 is similar to the user dashboard 204 and has certain key metrics that allow users to view a team's performance, the performance of individual members of the team, a member's rank on the team (e.g., top five members in the team for each metric), and the like. In one example embodiment, the team dashboard 280 provides more information exclusively to certain users, such as users who are enrolled in a subscription service.

In one example embodiment, the team dashboard 280 is generated by the team dashboard and usage report engine 152 and presented to a user, where the top card (e.g., the first page) of the team dashboard 280 contains the identity details (e.g., a user profile picture 208, a user name 212, a user title 216, a user company 220, and the like) and key metrics of the user dashboard 204 (e.g., the user's rank in the user's industry 284, a user's rank in the user's network 288, and the like), plus similar metrics corresponding to the user's team. A graph of the latest SSI score and a breakdown into the four key pillars may be generated and displayed. These include a donut chart 232 with breakdowns into the four pillars, sliders 236 depicting each of the four pillars, tooltips on each of the four pillars and the overall score, and the like. A histogram 252 illustrating the user's score over time may be generated and presented, and may include a week-over-week SSI score to illustrate the trend over a specified time period (such as the past month). Tooltips may be displayed as a user hovers a cursor over each individual data point.

In one example embodiment, an SSI score set for the user's team may be generated, including a donut chart 292 representing an average SSI team score for all the members of the user's team, a user's rank on the user's team, a donut chart 294 representing an average SSI team score for all the members of the user's industry, a donut chart 296 representing an average SSI team score for all the members of the user's network, and the like.

In one example embodiment, a team leader board 298 may be generated and presented on the team dashboard 280. The team leader board 298 may display, for example, an identity of the top five members in terms of their SSI score. A set of cards may be displayed on the team dashboard 280 and may contain suggested next steps for the user to improve their SSI score. In one example embodiment, a user may share the SSI score set along with an image of a breakdown of the SSI score, promotional text explaining the SSI score, a microsite link for other users to check their own score, and the like.

FIG. 2C is a detailed view of the histogram 252 of FIG. 2B, in accordance with an example embodiment. As described above, the histogram 252 of the user's score may include a week-over-week SSI team score to illustrate the trend over the past month. FIG. 2D is a detailed view of the donut graph 232 and the sliders 236 of FIG. 2B, in accordance with an example embodiment. As described above, the donut graph 232 illustrates the latest SSI score and how it breaks down into the four key pillars. The sliders 236 depict each of the four pillars. FIG. 2E is a detailed view of the team leader board 298 of FIG. 2B, in accordance with an example embodiment. The name of each member in the top five is displayed along with the member's SSI score.

An image containing the SSI score may be personalized for sharing with other users and is generated and shared by each user based on the current score values of each pillar for that user. Each pillar scales, for example, from 0 to 25. To support the SSI score sharing of members of a typical social network, there could be, for example, a total combination of 26*26*26*26˜=400K images. Moreover, each language has a different expression for the “out of” phrase, which means the final count of images to support 26 languages is about 11 million.

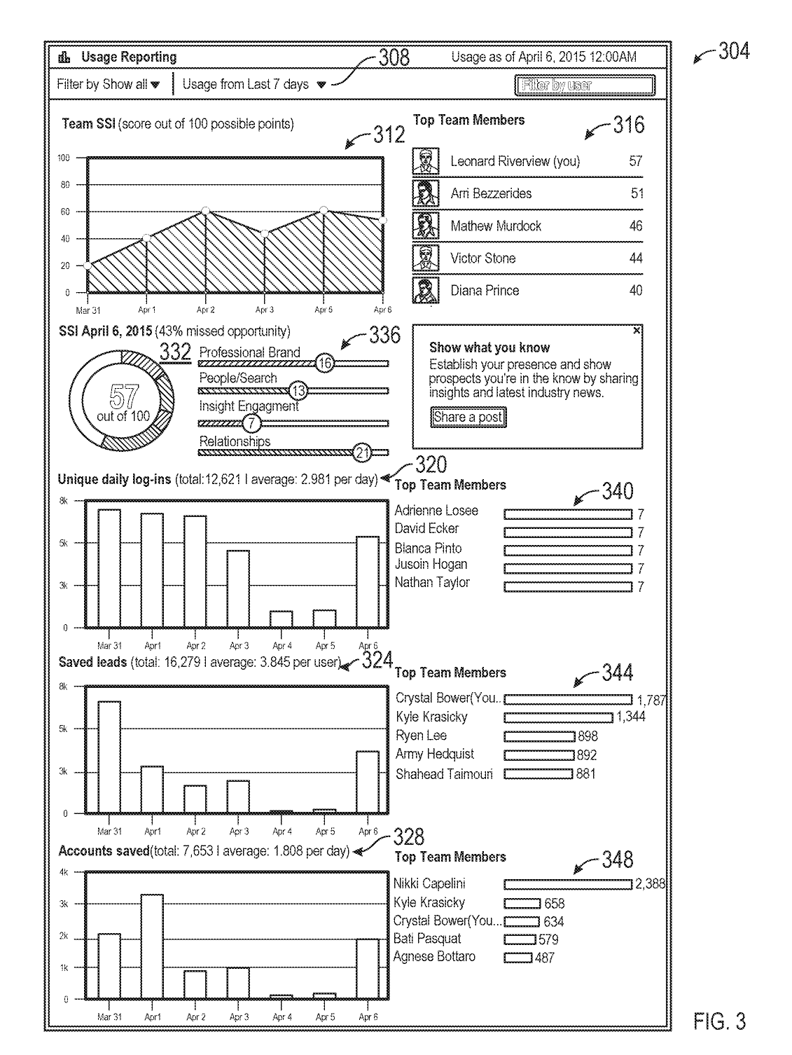

FIG. 3 is an example user interface 304 for displaying usage statistics associated with a team, in accordance with an example embodiment. In one example embodiment, a histogram 312 of the user's score over time may be generated and presented, and may include a week-over-week SSI team score to illustrate the trend over, for example, the past month. A team leader board 316 may be generated and presented. The team leader board 316 may display the top team members in terms of the SSI score. Graphs of the latest SSI score and how it breaks down into the four key pillars may also be generated and displayed. These include a donut chart 332 with breakdowns into the four pillars, sliders 336 depicting each of the four pillars, and the like. By default, the SSI score for the latest date in the histogram will be shown in the donut chart 332 and sliders 336.

Trends for key metrics of the SSI score over, for example, the past month may also be displayed. For example, a histogram 320 representing unique daily logins, a histogram 324 representing saved leads, and a histogram 328 representing saved accounts may be displayed. In addition, the team leader boards 340, 344, 348 for each metric may also be identified. In one example embodiment, the metrics of the SSI may include search counts, messages sent, in-mails sent, profiles viewed, unique connections, and the like. A user can filter the charts by team members to reflect the data of the selected users. By default, usage reporting shows, for example, seven day's worth of data, as indicated by the filter selection field 308.

FIG. 4A shows usage charts 400 associated with a team, in accordance with an example embodiment. The usage data can be filtered via a user-selectable timeframe 404 (e.g., by the month). When the date range extends beyond 90 days, the daily view is changed automatically to a monthly view. As shown in FIG. 4A, saved leads 412 average 0.14 per user and accounts saved 416 average 0.072 per user (unique daily log-ins 408 is partially shown). The top five team members 424, 428 are identified for each metric. FIG. 4B shows the daily view of the usage charts 400 when the months selected are within 90 days, in accordance with an example embodiment. A histogram 408, 412, 416 is displayed for each metric and the top five team members 420, 424, 428 are identified for each metric. FIG. 4C is the view of the usage charts 400 when the user selects date ranges beyond 90 days, in accordance with an example embodiment. Once again, a histogram 408, 412, 416 is displayed for each metric and the top five team members 420, 424, 428 are identified for each metric.

### High-Level Architecture

FIG. 5A is a block diagram of an example high-level architecture 500 for an SSI system, in accordance with an example embodiment. In one example embodiment, a microsite landing page 504 describes the concept of the defined SSI score and includes a login dialog that allows social network members to check their own SSI score. The user dashboard landing page 512 is the landing page of the user dashboard application for a registered user and may include an SSI score board. The content of the microsite and the user dashboard is provided by the user dashboard service 508.

The team dashboard landing page 516 is the landing page of the team dashboard application for a registered user and may include an SSI score board. The content of the team dashboard is provided by the team dashboard service 520. As described above, the SSI score is based on a variety of metrics maintained in a metrics database 544. FIG. 5B is a logical diagram of metric data 156 maintained in the metrics database 544, in accordance with an example embodiment. The metric data 156-1, . . . 156-4 (collectively known as metric data 156 herein) is, as illustrated in FIG. 5B, logically grouped according to the pillars that compose the SSI score. For example, the metric data 156-1 comprises the data corresponding to the Create Professional Brand pillar. Metric data 156-2 comprises the data corresponding to the Find the Right People pillar. Metric data 156-3 comprises the data corresponding to the Engage with Insights pillar. Metric data 156-4 comprises the data corresponding to the Build Strong Relationships pillar.

The metric data 156 is processed, for example, on a daily basis for all members of the social network. In one example embodiment, the metric data 156 is processed as a Hadoop job by a distributed processing system 532. The metrics and results provided to the microsite landing page 504 and the user dashboard landing page 512 by the user dashboard service 508 are generated by the distributed processing system 532 and stored in the user storage system 524.

The metrics and results generated by the distributed processing system 532 are also provided to the team metrics processing system 540 to compute the metrics and results provided to the team dashboard landing page 516 by the team dashboard service 520. The metrics and results generated by the team metrics processing system 540 are stored in the team storage system 536. The distributed processing system 532 and the team metrics processing system 540 may be implemented by the social networking server 112 of FIG. 1B.

### SSI Models, Views, and Controllers (MVC)

In one example embodiment, an SSI controller client enforces user authentication and returns the initial payload of the microsite landing page 504. The content of the payload may include the individual SSI score of the logged-in member (and may include the overall score and sub-scores), the SSI network and industry ranks, member information (including a member profile picture 108, a name 112, a title 116, and the like), the URL link of the chooser page or the URL link of the user dashboard landing page 512 (depending if the member subscribes to the user dashboard), a Boolean indicating whether the user subscribes to the user dashboard, an endtime parameter (if the user subscribes to the user dashboard), and the like. The boolean may be used by a client to decide whether to display messages such as “upgrade to user dashboard” or “get your score in user dashboard.” The parameter endtime is passed to a history application program interface (API) to get the latest data (e.g., data that was acquired earlier than the endtime parameter). A query is made for the latest timestamp; the endtime parameter is derived from this timestamp.

### SSI User Dashboard

The SSI user dashboard enforces authentication via the user dashboard landing page 512 and returns the initial payload of the user dashboard. The content of the payload may include the individual SSI score of the social network member (e.g., the overall score and subscores), the team, network, and industry SSI scores and ranks, member information (including a member profile picture, a name, a title, and the like), the endtime parameter (if the user subscribes to the user dashboard), and the like. The endtime parameter is passed to the history API as well as a leader board API to get the latest data (e.g., data that is acquired earlier than the endtime parameter).

### Usage Reporting Design

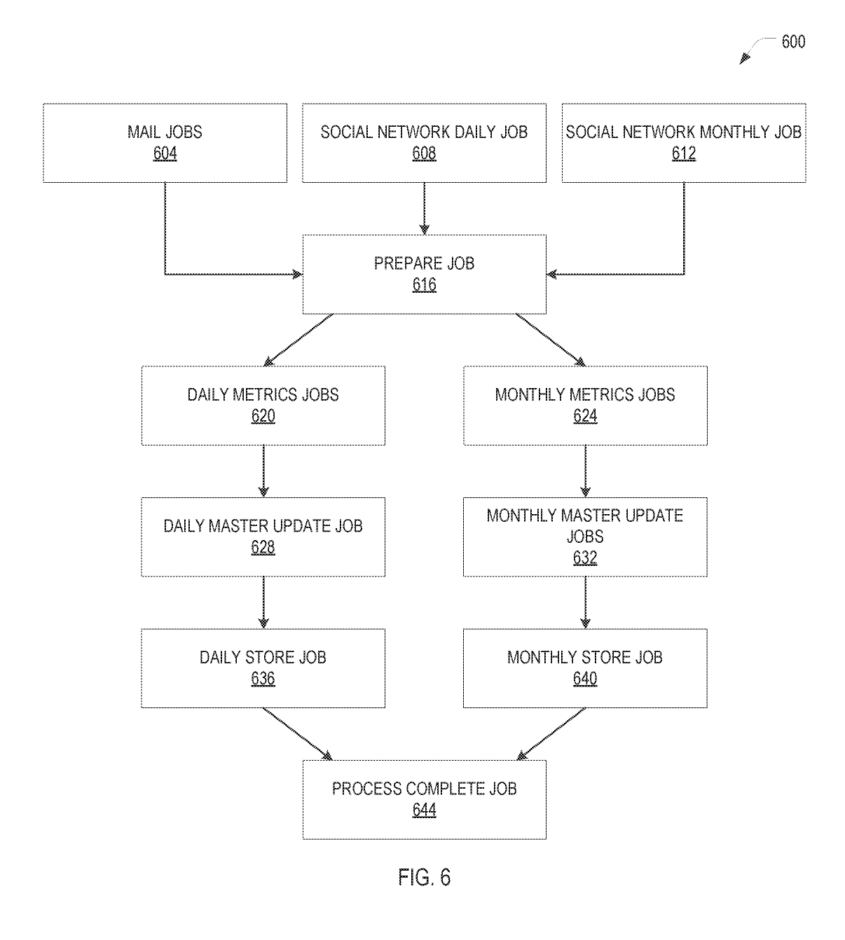

FIG. 6 shows an example high level usage reporting design and the main blocks of the usage reporting architecture, in accordance with an example embodiment. Mail jobs 604 is a group of jobs that calculate data related to inbound electronic mail for each member, such as inbound emails sent, inbound emails accepted, inbound emails pending, inbound emails declined, and the like. In one example embodiment, this data is not queried, but is used in the subsequent Hadoop job. A social network daily job 608 calculates, for each member, a count of searches performed, a count of profiles viewed, a count of active days, and the like on a daily basis. A social network monthly job 612 calculates, for each member, a count of searches performed, a count of profiles viewed, a count of active days, and the like on a monthly basis. A prepare job 616 monitors for the completion of the mail jobs 604, the social network daily job 608, and the social network monthly job 612 and prepares for the next set of jobs.

Daily metrics jobs 620 is a group of jobs that calculate and combine all the metrics, for each member, on a daily basis. The metrics include, but are not limited to, messages sent, inbound electronic mail sent, searches performed, profiles viewed, unique connections, the SSI score, the pillars, and the like. Monthly metrics jobs 624 is a group of jobs that calculate and combine all the metrics, for each member, on a monthly basis.

A daily master update job 628 loads the metrics calculated in the preceding jobs for a specified time period, such as the past five days, and combines this data with the metrics accumulated since the beginning of the system. Monthly master update jobs 632 is a group of jobs that sum the metrics for a specified time period, such as the past three months, on a monthly basis and combine this data with the metrics accumulated since the beginning of the system.

A daily store job 636 stores the daily data for future use and the monthly store job 640 stores the monthly data for future use. A process complete job 644 monitors for the completion of all the preceding jobs.

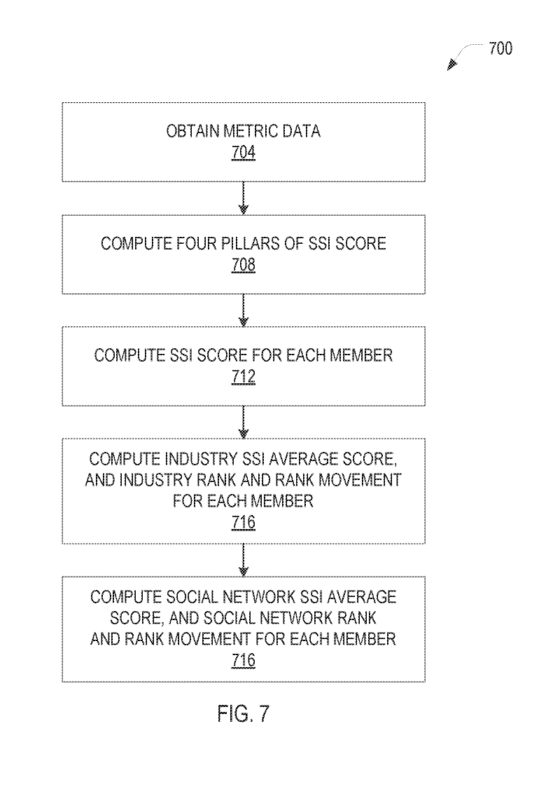

FIG. 7 is a flowchart of an example method 700 for generating an SSI user score set, in accordance with an example embodiment. In one example embodiment, the method 700 is performed by, for example, the distributed processing system 532.

In one example embodiment, the metric data 156-1 is obtained to compute the Create Professional Brand pillar, the metric data 156-2 is obtained to compute the Find the Right People pillar, the metric data 156-3 is obtained to compute the Engage with Insights pillar, and the metric data 156-4 is obtained to compute the Build Strong Relationships pillar for each member (operation 704).

Each of the four pillars is computed based on the obtained metric data 156 (operation 708). The SSI score is computed for each member by summing the products of 0.25 multiplied by each of the four metric pillars (operation 712). The donut chart 256 representing the average SSI score of the user's industry, the user's rank 160 in the industry, and the user's recent rank movement 264 in the user's industry are computed (operation 716). The donut chart 268 representing the average SSI score of the members in the user's social network, the user's rank 272 in the user's social network, and the user's recent rank movement 276 in the user's social network are computed (operation 720).

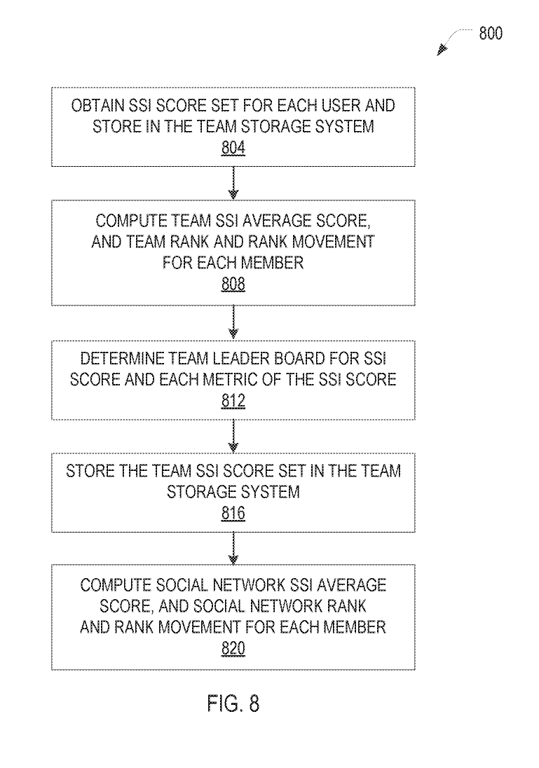

FIG. 8 is a flowchart of an example method 800 for generating an SSI team score set, in accordance with an example embodiment. In one example embodiment, the method 800 is performed by, for example, the team metrics processing system 540.

In one example embodiment, the SSI user score set produced by the distributed processing system 532 is obtained and stored in the team storage system 536 (operation 804). The average SSI team score for the user's team, the user's rank 292 on the user's team, and the user's recent rank movement 276 are computed (operation 808). A team leader board 298 is determined based on the SSI score and each metric that is an element of the SSI score for the present time period (operation 812). The SSI team score set is stored in the team storage system 536 (operation 816). The average SSI score for the members of the user's team, the user's rank 292 on the user's team, and the user's recent rank movement 276 are computed for each member (operation 820).

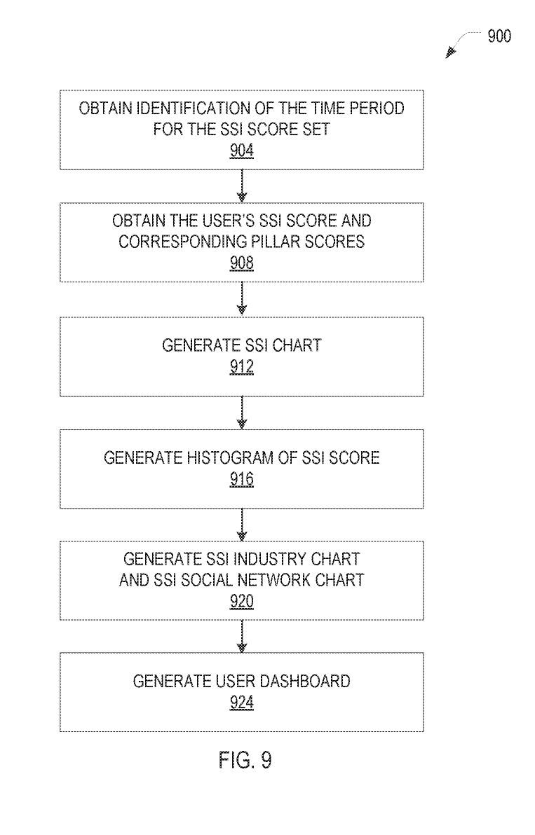

FIG. 9 is a flowchart of an example method 900 for generating the user dashboard 104, in accordance with an example embodiment. In one example embodiment, the method 900 is performed by, for example, the user dashboard service 508.

In one example embodiment, an identification of the time period for the user's SSI scores and corresponding pillar scores is obtained (operation 904). The user's SSI scores and corresponding pillar scores are obtained for the specified time period (operation 908). An SSI chart, such as the donut chart 232, is generated based on the user's SSI score and the corresponding four pillars (operation 912). A histogram 252 of the user's SSI score is generated (operation 916). An SSI industry chart, such as the donut chart 256, and an SSI social network chart, such as the donut chart 268, are generated based on the user's SSI score and the corresponding four pillars (operation 920). The user dashboard 104 is generated based on the user's SSI score, the four pillar scores, the SSI chart, the histogram 252, the industry rank, and the social network rank (operation 924).

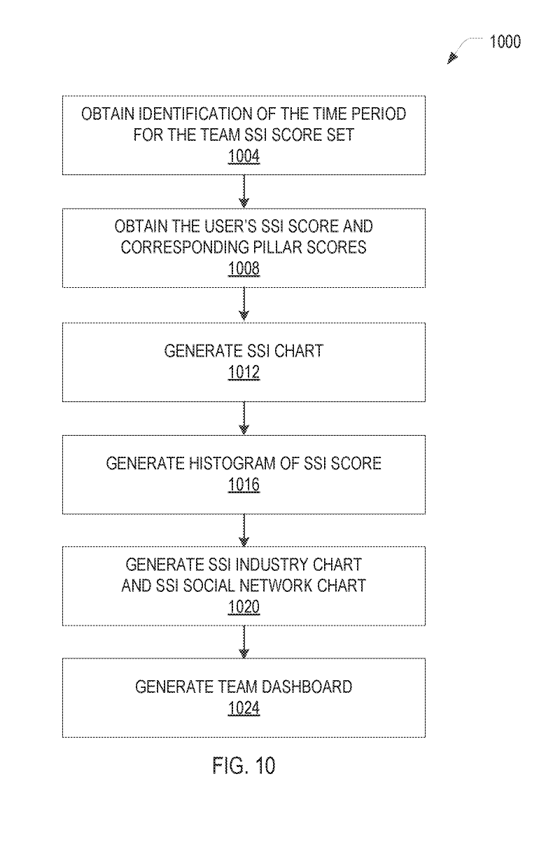

FIG. 10 is a flowchart of an example method 1000 for generating the team dashboard 516, in accordance with an example embodiment. In one example embodiment, the method 1000 is performed by, for example, the team dashboard service 520.

In one example embodiment, an identification of the time period for the team SSI scores and corresponding pillar scores is obtained (operation 1004). The user's SSI scores and corresponding pillar scores for the specified time period are obtained (operation 1008). An SSI chart, such as the donut chart 232, is generated based on the user's SSI score and the corresponding four pillars (operation 1012). A histogram 252 of the user's score is generated (operation 1016). An SSI industry chart, such as the donut chart 294, and an SSI social network chart, such as the donut chart 296, are generated based on the user's SSI score and the corresponding four pillars (operation 1020). The team dashboard 280 is generated based on the user's SSI score, the four pillar scores, the donut chart 232, the histogram 252, the industry rank, the social network rank, and the team leader board (operation 1024).

FIG. 11 shows a flowchart for an example method 1100 for generating an example team usage report, in accordance with an example embodiment. In one example embodiment, an identification of the time period for the team usage report is obtained (operation 1104). The metric data 156-1 is obtained to compute the team Create Professional Brand pillar, the metric data 156-2 is obtained to compute the team Find the Right People pillar, the metric data 156-3 is obtained to compute the team Engage with Insights pillar, and the metric data 156-4 is obtained to compute the team Build Strong Relationships pillar for each member (operation 1108). The SSI score for the team is computed based on the computed team pillars (operation 1112).

In one example embodiment, the usage metrics are computed (operation 1116). For example, the count of unique daily log-ins may be obtained for each team member and a count of unique daily log-ins may be computed for the team. The count of saved leads may be obtained for each team member and a count of saved leads may be computed for the team. The count of accounts saved may be obtained for each team member and a count of accounts saved may be computed for the team. The histograms 320, 324, 328 and team leader boards 340, 344, 348 for each usage metric is generated (operation 1120). The team usage report is generated based on the team's SSI score, the four team pillar scores, the histograms 320, 324, 328, and the team leader boards 340, 344, 348 (operation 1124).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., APIs).

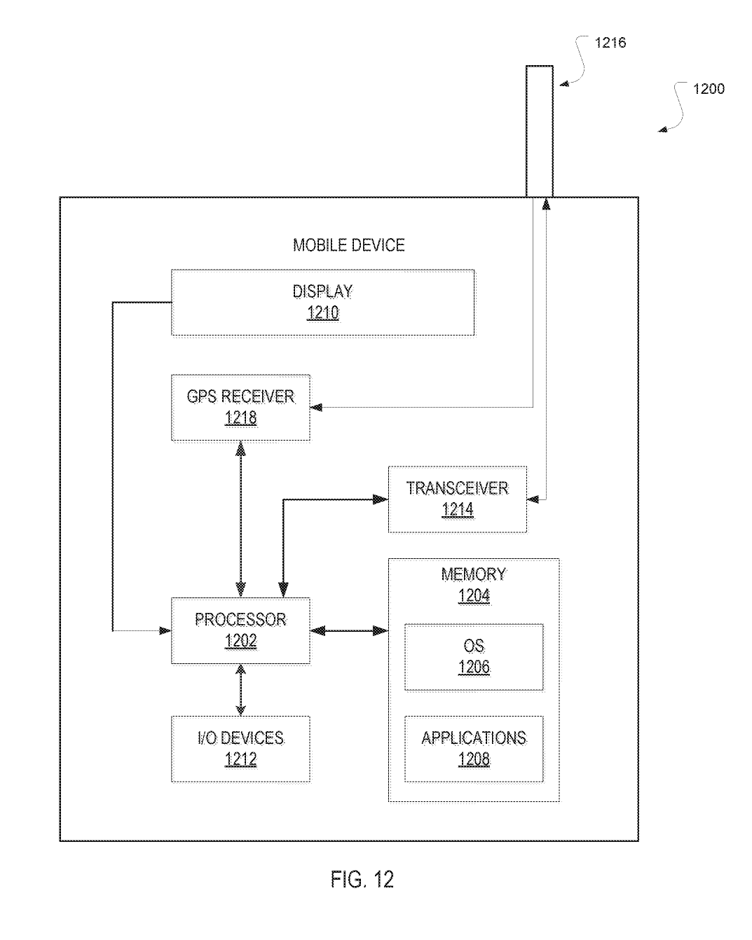

FIG. 12 is a block diagram illustrating a mobile device 1200, according to an example embodiment. The mobile device 1200 can include a processor 1202. The processor 1202 can be any of a variety of different types of commercially available processors suitable for mobile devices 1200 (for example, an XScale architecture microprocessor, a microprocessor without interlocked pipeline stages (MIPS) architecture processor, or another type of processor). A memory 1204, such as a random access memory (RAM), a flash memory, or another type of memory, is typically accessible to the processor 1202. The memory 1204 can be adapted to store an operating system (OS) 1206, as well as applications 1208, such as a mobile location-enabled application that can provide location-based services (LBSs) to a user. The processor 1202 can be coupled, either directly or via appropriate intermediary hardware, to a display 1210 and to one or more input/output (I/O) devices 1212, such as a keypad, a touch panel sensor, and a microphone. Similarly, in some embodiments, the processor 1202 can be coupled to a transceiver 1214 that interfaces with an antenna 1216. The transceiver 1214 can be configured to both transmit and receive cellular network signals, wireless data signals, or other types of signals via the antenna 1216, depending on the nature of the mobile device 1200. Further, in some configurations, a global positioning system (GPS) receiver 1218 can also make use of the antenna 1216 to receive GPS signals.

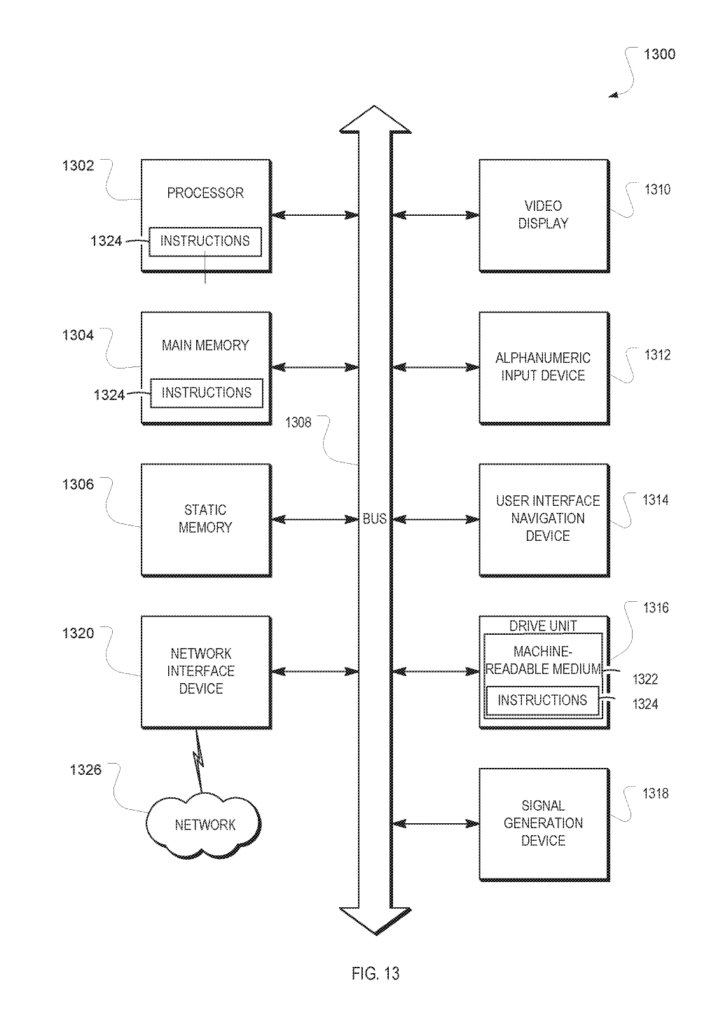

FIG. 13 is a block diagram of a computer processing system 1300 within which a set of instructions 1324 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed as software-as-a-service (SaaS), by an application service provider (ASP), or by utility computing providers. The computer may be a server computer, a personal computer (PC), a tablet PC, a personal digital assistant (PDA), a cellular telephone, or any processing device capable of executing a set of instructions 1324 (sequential or otherwise) that specify actions to be taken by that device. Further, while only a single computer is illustrated, the term “computer” shall also be taken to include any collection of computers that, individually or jointly, execute a set (or multiple sets) of instructions 1324 to perform any one or more of the methodologies discussed herein.

The example computer processing system 1300 includes a processor 1302 (e.g., a central processing unit (CPU), a graphics processing unit (GPU), or both), a main memory 1304, and a static memory 1306, which communicate with each other via a bus 1308. The computer processing system 1300 may further include a video display 1310 (e.g., a plasma display, a liquid crystal display (LCD), or a cathode ray tube (CRT)). The computer processing system 1300 also includes an alphanumeric input device 1312 (e.g., a keyboard), a user interface navigation device 1314 (e.g., a mouse and/or touch screen), a drive unit 1316, a signal generation device 1318 (e.g., a speaker), and a network interface device 1320.

The drive unit 1316 includes a machine-readable medium 1322 on which is stored one or more sets of instructions 1324 and data structures embodying or utilized by any one or more of the methodologies or functions described herein. The instructions 1324 may also reside, completely or at least partially, within the main memory 1304, the static memory 1306, and/or the processor 1302 during execution thereof by the computer processing system 1300, with the main memory 1304, the static memory 1306, and the processor 1302 also constituting tangible machine-readable media 1322.

The instructions 1324 may further be transmitted or received over a network 1326 via the network interface device 1320 utilizing any one of a number of well-known transfer protocols (e.g., Hypertext Transfer Protocol (HTTP)).

While the machine-readable medium 1322 is shown, in an example embodiment, to be a single medium, the term “machine-readable medium” should be taken to include a single medium or multiple media (e.g., a centralized or distributed database, and/or associated caches and servers) that store the one or more sets of instructions 1324. The term “machine-readable medium” shall also be taken to include any medium that is capable of storing, encoding, or carrying a set of instructions 1324 for execution by the computer and that cause the computer to perform any one or more of the methodologies of the present application, or that is capable of storing, encoding, or carrying data structures utilized by or associated with such a set of instructions 1324. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method, the method comprising:
obtaining metric data corresponding to a user of a social network system;
computing one or more components of a social selling index score;
computing the social selling index score based on the one or more components;
generating a graphical interface, using at least one hardware processor, based on the one or more components and the social selling index score, the graphical interface having a first portion that includes a chart representing a first element associated with the social selling index score and a second portion that includes text representing a second element associated with the social selling index score.

2. The method of claim 1, wherein the graphical interface includes a donut chart representing the one or more components.

3. The method of claim 1, wherein the graphical interface includes one or more sliders representing the one or more components.

4. The method of claim 1, wherein the graphical interface includes a histogram of the social selling index score over time.

5. The method of claim 1, further comprising computing a social selling index score for an industry and wherein the graphical interface includes a donut chart representing one or more components of the industry social selling index score.

6. The method of claim 1, further comprising computing a social selling index score for a network of a user and wherein the graphical interface includes a donut chart representing one or more components of the network social selling index score.

7. The method of claim 1, further comprising computing a social selling index score for a team of a user and wherein the graphical interface includes a donut chart representing one or more components of the team social selling index score.

8. An apparatus comprising:
one or more hardware processors;
memory to store instructions that, when executed by the one or more hardware processors perform operations comprising:
obtaining metric data corresponding to a user of a social network system;
computing one or more components of a social selling index score;
computing the social selling index score based on the one or more components;
generating a graphical interface, using at least one hardware processor, based on the one or more components and the social selling index score, the graphical interface having a first portion that includes a chart representing a first element associated with the social selling index score and a second portion that includes text representing a second element associated with the social selling index score.

9. The apparatus of claim 8, wherein the graphical interface includes a donut chart representing the one or more components.

10. The apparatus of claim 8, wherein the graphical interface includes one or more sliders representing the one or more components.

11. The apparatus of claim 8, wherein the graphical interface includes a histogram of the social selling index score over time.

12. The apparatus of claim 8, the operations further comprising computing a social selling index score for an industry and wherein the graphical interface includes a donut chart representing one or more components of the industry social selling index score.

13. The apparatus of claim 8, the operations further comprising computing a social selling index score for a network of a user and wherein the graphical interface includes a donut chart representing one or more components of the network social selling index score.

14. The apparatus of claim 8, the operations further comprising computing a social selling index score for a team of a user and wherein the graphical interface includes a donut chart representing one or more components of the team social selling index score.

15. A non-transitory machine-readable storage medium comprising instructions, which when implemented by one or more machines, cause the one or more machines to perform operations comprising:
obtaining metric data corresponding to a user of a social network system;
computing one or more components of a social selling index score;
computing the social selling index score based on the one or more components;
generating a graphical interface, using at least one hardware processor, based on the one or more components and the social selling index score, the graphical interface having a first portion that includes a chart representing a first element associated with the social selling index score and a second portion that includes text representing a second element associated with the social selling index score.

16. The non-transitory machine-readable storage medium of claim 15, wherein the graphical interface includes a donut chart representing the one or more components.

17. The non-transitory machine-readable storage medium of claim 15, wherein the graphical interface includes a histogram of the social selling index score over time.

18. The non-transitory machine-readable storage medium of claim 15, the operations further comprising computing a social selling index score for an industry and wherein the graphical interface includes a donut chart representing one or more components of the industry social selling index score.

19. The non-transitory machine-readable storage medium of claim 15, the operations further comprising computing a social selling index score for a network of a user and wherein the graphical interface includes a donut chart representing one or more components of the network social selling index score.

20. The non-transitory machine-readable storage medium of claim 15, the operations further comprising computing a social selling index score for a team of a user and wherein the graphical interface includes a donut chart representing one or more components of the team social selling index score.
